(19) United States
(12) Patent Application Publication
(10) Pub. No.: US 2009/0033685 A1
(43) Pub. Date: Feb. 5, 2009

(54) Organic light emitting display and driving method thereof

(76) Inventors: Young-Jong Park, Suwon-si (KR); Jeong-Min Seo, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/149,729

(22) Filed: May 7, 2008

(30) Foreign Application Priority Data
Aug. 2, 2007 (KR) 10-2007-0077709

(51) Int. Cl. G09G 5/10; G09G 3/30; G09G 5/02

(52) U.S. Cl. 345/690; 345/77; 345/601

(57) ABSTRACT

The present invention provides an organic light emitting display and a driving method the same capable of improving image quality by reducing luminance variations depending on temperature. The organic light emitting display and a driving method of the present invention includes a temperature sensor unit sensing ambient temperature and outputting temperature compensation signals corresponding to the ambient temperature, a light sensor unit sensing ambient light and outputting light control signals corresponding the ambient light, a correction unit generating gamma correction signals corresponding to the temperature compensation signals and the light control signals, and a data driver generating data signals corresponding to the gamma correction.

### CLAIM OF PRIORITY

This application makes reference to, incorporates the same herein, and claims all benefits accruing under 35 U.S.C. §119 from an application for ORGANIC LIGHT EMITTING DISPLAY AND DRIVING METHOD THEREOF earlier filed in the Korean Intellectual Property Office on the 2^{nd} of August 2007 and there duly assigned Serial No. 10-2007-0077709.

### BACKGROUND OF THE INVENTION

1. Field of the Invention

The present invention relates to an organic light emitting display and a driving method of the same, and more specifically to an organic light emitting display and a driving method of the same that improves image quality by reducing luminance variations depending on temperature.

2. Description of the Related Art

A flat panel display includes a plurality of pixels arranged on a substrate in a form of a two dimensional array. A scan line and a data line are coupled to each pixel, and data signals are selectively applied to the pixel, displaying an image corresponding to the data signal.

The flat panel display is used for displays of devices such as a personal computer, a cellular phone, and a personal digital assistants (PDA), etc., or for monitors of various information equipments. Among flat panel displays, there are a liquid crystal display (LCD) using a liquid crystal panel, an organic light emitting display using an organic light emitting device, and a plasma display panel (PDP) using a plasma panel, etc. Among the displays, the organic light emitting display, which is excellent in luminous efficiency, brightness, and viewing angle and has a rapid response speed, has been spotlighted.

One of the trends of recent technological development is to reduce the thickness of the flat panel displays. Heat generated from a driver driving the slim flat panel display does not quickly dissipate, so that the internal temperature of the flat panel display rises due to the heat. In particular, because an organic light emitting display displays gray scale images by an amount of current flowing into the organic light emitting diode, the rise of temperature has an adverse effect on accurately controlling an amount of current. Therefore, gray scale images may not be properly displayed if the temperature is out of a desired range.

### SUMMARY OF THE INVENTION

Therefore, it is an object of the present invention to provide an organic light emitting display and a driving method of the same capable of improving image quality by reducing luminance variations that can be caused by ambient temperature.

In order to accomplish the above object, there is provided an organic light emitting display, according to a first aspect of the present invention, which includes a pixel unit for displaying an image, a temperature sensor unit for measuring ambient temperature and for outputting a temperature compensation signal representing the ambient temperature, a light sensor unit for sensing intensity of ambient light and for outputting a light control signal representing the intensity of the ambient light, a correction unit for receiving the temperature compensation signal and the light control signal and for outputting a gamma correction signal corresponding to the temperature compensation signal and the light control signal, and a data driver for receiving the gamma correction signal and for generating a data signal corresponding to the gamma correction signal. The data driver supplies the data signal to the pixel unit in order to drive the pixel unit.

The temperature sensor unit may further include a temperature sensing sensor measuring the ambient temperature, a temperature lookup table storing correction values that depends on the ambient temperature, and a signal generator coupled to the temperature sensing sensor and the temperature lookup table. The signal generator looks up the temperature lookup table to find a correction value of the measured ambient temperature, and outputs the temperature compensation signal corresponding to the found correction value.

The correction unit may further include a first signal processor receiving the temperature compensation signal and the light control signal and outputting a selection signal corresponding to the temperature compensation signal and the light control signal, a register unit including a plurality of registers, each of which has a unique register value, and a first selector selecting one of the registers based on the selection signal. The first selector outputs the register value of the selected register as the gamma correction signal.

The data driver may further include a gamma correction circuit receiving the gamma correction signal. The gamma correction circuit performs a gamma correction based on the gamma. correction signal. The first signal processor may add the temperature compensation signal to the light control signal to generate the selection signal.

In order to accomplish the above object, there is also provided an organic light emitting display, according to a second aspect of the present invention, which includes a pixel for emitting light, a temperature sensor unit sensing ambient temperature, and outputting a temperature compensation signal corresponding to the ambient temperature, and a luminance controller receiving the temperature compensation signal and image signals. The luminance controller controls a pulse width of a light emitting control signal based on the temperature compensation signal and the image signals. The light emitting control signal controls light emission of the pixel.

The luminance controller may include a data summer adding gray levels of the image signals of a single image frame to generate frame data, a data lookup table storing pulse widths of the light emitting control signals as a function of an input parameter, and a second signal processor coupled to the data summer and the data lookup table. The second signal processor receives the temperature compensation signal, and generates the input parameter based on the temperature compensation signal and the frame data. The second signal processor looks up the data lookup table to find a width of the light emitting control signal corresponding to the input parameter, and outputs a pulse width control signal to control the pulse width of the light emitting control signal.

In order to accomplish the above object, there is provided a driving method of an organic light emitting display, which includes steps of measuring ambient temperature, generating a temperature compensation signal that represents the ambient temperature, measuring intensity of ambient light, generating a light control signal that represents the intensity of ambient light, generating a data signal that depends on the temperature compensation signal and the light control signal, and transferring the data signal to the pixel unit to drive a pixel unit of the organic light emitting display.

The step of generating the data signals may comprise steps of dividing a plurality of steps corresponding to the luminance of ambient light, setting a plurality of correction values corresponding to each step, and selecting one of the plurality of steps corresponding to the light control signals and the temperature compensation signals.

In order to accomplish the above object, there is also provided a driving method of an organic light emitting display, which includes steps of measuring ambient temperature, generating a temperature compensation signal that represents the ambient temperature, generating a frame data by adding gray levels of image signals of a single image frame, determining a pulse width of a light emitting control signal based on the temperature compensation signal and the frame data. The light emitting control signal controls light emission of a pixel of the organic light emitting display.

The method may further include steps of generating an input parameter by adding the temperature compensation signal to the frame data, and looking up a data lookup table to find a width of the light emitting control signal corresponding to the input parameter.

The organic light emitting display and the driving method the same can compensate luminance variations according to temperature so that the luminance variations according temperature can be prevented, making it possible to improve image quality.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 shows a circuit diagram representing a pixel adopted in an organic light emitting display;

FIG. 2 shows a circuit diagram of an organic light emitting display of the present invention;

FIG. 3 shows a block diagram of a temperature sensor unit shown in FIG. 2;

FIG. 4 shows a block diagram of a light sensor unit adopted in the organic light emitting display shown in FIG. 2;

FIG. 5 shows a block diagram of one example of a correction unit shown in FIG. 2;

FIG. 6 shows one example of a gamma correction circuit shown in FIG. 2; and

FIG. 7 shows one example of a luminance controller adopted in the organic light emitting display of the present invention.

### DETAILED DESCRIPTION OF THE INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are essential to the complete understanding of the invention are omitted for clarity. Also, like reference numerals refer to like elements throughout.

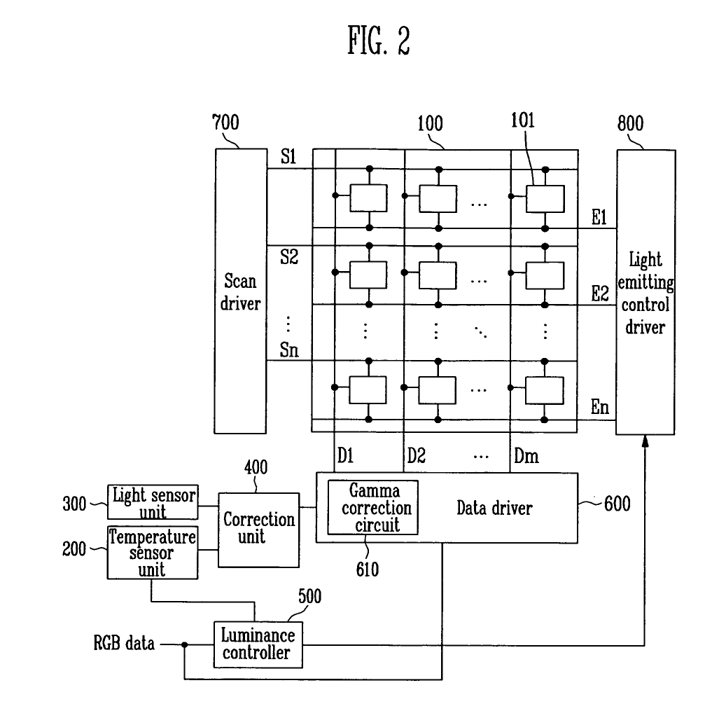

FIG. 2 is a view showing a circuit diagram of an organic light emitting display of the present invention. Referring to FIG. 2, the organic light emitting display includes a pixel unit 100, a temperature sensor unit 200, a light sensor unit 300, a correction unit 400, a luminance controller 500, a data driver 600, a scan driver 700, and a light emitting control driver 800.

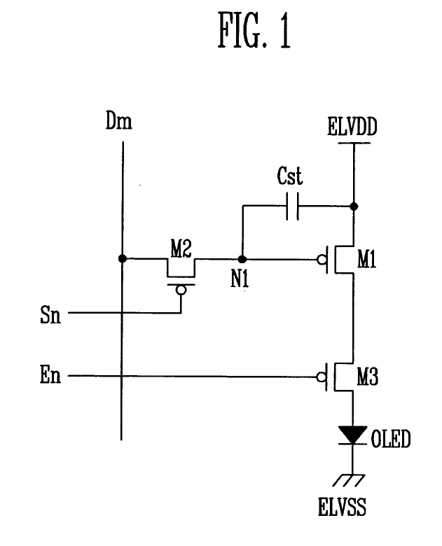

The pixel unit 100 includes a plurality of pixels 101, a plurality of scan lines S1, S2, . . . Sn, a plurality of light emitting control liens E1, E2, . . . En, and a plurality of data lines D1, D2, . . . Dm. The pixel 101 includes a pixel circuit and an organic light emitting diode, which is shown in FIG. 1.

FIG. 1 is a circuit diagram representing the pixel adopted in the organic light emitting display. Referring to FIG. 1, the pixel includes a first transistor M1, a second transistor M2, a third transistor M3, a capacitor Cst, and an organic light emitting diode (OLED).

The source of the first transistor M1 is coupled to a first power supply ELVDD, the drain thereof is coupled to the source of the third transistor M3, and the gate thereof is coupled to a first node N1. Therefore, driving current flows from the source of the first transistor M1 to the drain of the first transistor M1 depending on the voltage of the first node N1.

The source of the second transistor M2 is coupled to a data line Dm, the drain thereof is coupled to the first node N1, and the gate thereof is coupled to a scan line Sn so that a data signal from the data line Dm is transferred to the first node N1 depending on the scan signal transferred through the scan line Sn.

The source of the third transistor M3 is coupled to the drain of the first transistor M1, the drain thereof is coupled to an organic light emitting diode (OLED), and the gate thereof is coupled to a light emitting control line En, so that the flow of driving current flowing through the first transistor M1 is controlled by a signal from the light emitting control line En.

The first electrode of the capacitor Cst is coupled to the first power source ELVDD and the second electrode thereof is coupled to the first node N I so that the voltage of the first node N1 is maintained through the capacitor Cst.

The organic light emitting diode (OLED) includes an anode electrode, a cathode electrode, and a light emitting layer positioned between the anode electrode and the cathode electrode. The anode electrode is coupled to the drain of the third transistor M3 and the cathode electrode is coupled to the second power supply ELVSS having voltage lower than that of the first power supply ELVDD. And, when the current flows from the anode electrode to the cathode electrode, the brightness changes depending on the amount of flowing current so that gray scales can be realized.

The temperature sensor unit 200 generates temperature compensation signals according to temperature. The organic light emitting diode is a device displaying gray scales by an amount of current. Because the amount of current changes depending on the temperature, the temperature compensation signals are generated as a result of the detection of the temperature in the temperature sensor unit 200. The temperature compensation signals are transferred to the correction unit 400 and the luminance controller 500 to give effect on the operations of the correction unit 400 and the luminance controller 500.

The light sensor unit 300 detects ambient light to output light control signals corresponding to the amount of the ambient light. If the luminance of ambient light measured in the light sensor unit 300 is high, the luminance displayed in the pixel unit 100 becomes high, and if the luminance of ambient light measured in the light sensor unit 300 is low, the luminance displayed in the pixel unit 100 becomes low.

The correction unit 400 selects gamma correction values by receiving the temperature compensation signals and the light control signals, so that the correction unit 400 applies different gamma correction values according to the ambient temperature and the ambient light intensity.

The luminance controller 500 is an apparatus setting limiting values of luminance in a single image frame by adding gray scale values (or gray levels) of image signals that are input during the single image frame, and prevents the gray scale values from exceeding the limiting values of luminance. The luminance controller 500 is coupled to the light emitting control driver 800, and controls pulse widths of the light emitting control signals based on the image signals of the image frame. At this time, the luminance controller 500 also receives the temperature compensation signals from the temperature sensor unit 200, and further controls the pulse widths of the light emitting control signals according to the temperature compensation signals. Therefore, the limiting range of luminance can be changed depending on variations in temperature and the image signals.

The data driver 600 is coupled to the plurality of data lines D1, D2, . . . ,Dm to transfer data signals to the pixel unit 100. The data driver 600 receives image information, such as RGB data, from an external apparatus, and generates data signals. The data signals are transferred to the pixel 21 unit 100 through the plurality of data lines D1, D2, . . . ,Dm. The data driver 600 includes a gamma correction circuit 610 that receives the gamma correction signals from the correction unit 400, and performs different gamma corrections according to the gamma correction signals.

The scan driver 700 is coupled to the plurality of scan lines S1, S2, . . . ,Sn to transfer scan signals to the pixel unit 100. The data signals are transferred to each pixel of the pixel unit 100 selected by means of the scan signals.

The light emitting control driver 800 is coupled to the plurality of light emitting control lines E1, E2, . . . , En to transfer light emitting control signals to each pixel of the pixel unit 100. Current flow into the pixel unit 100 is controlled by the light emitting control signals. The pulse widths of the light emitting control signals are determined by sum of the temperature compensation signals and the frame data of the image signals in one frame period. The pulse widths change according to the temperature variations and the variations of the image signals that are input in one frame.

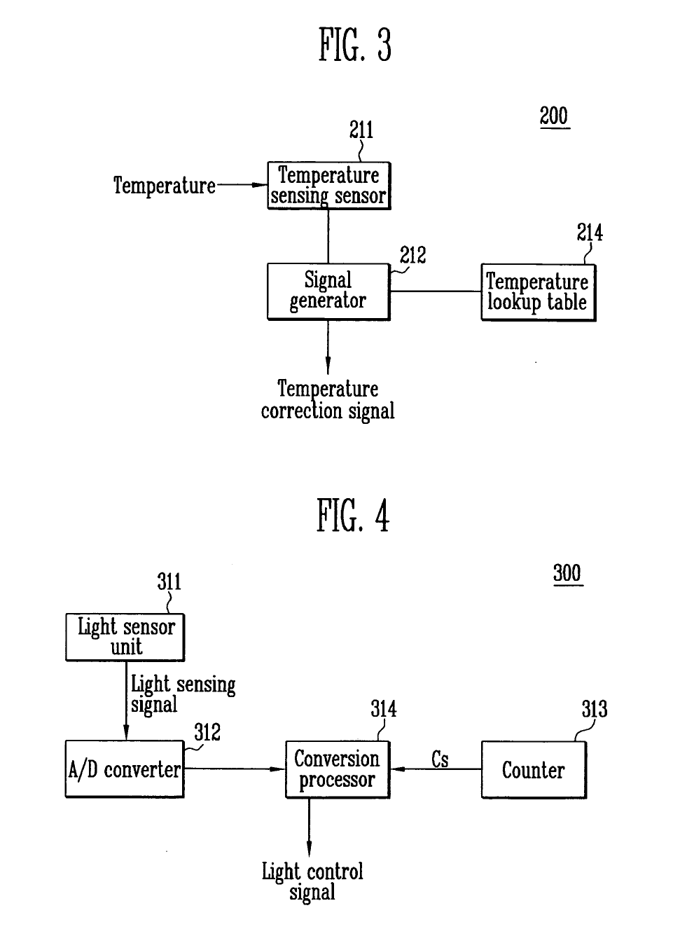

FIG. 3 is a view showing a block diagram of a temperature sensor unit shown in FIG. 2. Referring to FIG. 3, a temperature sensor unit 200 includes a temperature sensing sensor 211, a signals generator 212, and a temperature lookup table 214. The temperature sensing sensor 211 senses ambient temperature and generates sensing signals representing the ambient temperature. The sensing signals are transferred to the signal generator 212. The temperature sensing sensor 211 can be disposed outside the organic light emitting display to sense the ambient temperature, or can be positioned within the organic light emitting display to sense the temperature inside the organic light emitting display.

The signal generator 212 looks up a temperature lookup table 214 to find a correction value that corresponds to the sensing signals transferred from the temperature sensing sensor 211. The signal generator 121 generates appropriate temperature correction signals based on the correction value found in the temperature lookup table 214. The temperature correction signals are transferred to the correction unit 400 and the luminance controller 500, so that the gamma correction and luminance limiting range can be determined by the temperature compensation signals.

The temperature lookup table 214 stores values corresponding to the sensed temperature in the temperature sensing sensor 211, and transfers the values to the signal generator. 212, so that the temperature correction signals corresponding to the sensed temperature are output.

FIG. 4 is a view showing a diagram of a light sensor unit adopted in the organic light emitting display shown in FIG. 2. Referring to FIG. 4, the light sensor unit 300 includes a light sensor 311, an analog-digital (A/D) converter 312, a counter 313, and a conversion processor 314.

The light sensor 311 measures the brightness of ambient light, and divides the brightness of ambient light into a plurality of levels to output analog sensing signals corresponding to the brightness of each level.

The A/D converter 312 compares the analog sensing signals output from the light sensor 311 with reference, and outputs corresponding digital sensing signals. For example, the A/D converter 312 outputs a sensing signal of “11” if the ambient brightness is the brightest level, and outputs a sensing signal of “10” if ambient brightness is less than the brightest level. The AID converter 312 outputs a sensing signal of “01” if the ambient brightness is less than the level corresponding to the signal of “10,” and outputs a sensing signal of “00” if the ambient brightness is the darkest.

The counter 313 counts a predetermined number during predetermined time by being initiated by a vertical synchronization signal Vsync that is supplied from an external apparatus. The counter 313 outputs corresponding counting signals Cs to the conversion processor 314. For example, in the case of the counter 313 having 2-bit binary number, the counter 313 is initialized into “00” when the vertical synchronization signal Vsync is input. The counter 313, then, counts up to “11”, shifting clock signals in sequence. If the vertical synchronization signal Vsync is input again to the counter 313, the counter 313 is reset to the initialization state. Through the above operations, the counter 313 sequentially counts from “00” to “11” during one frame. And, the counting signals Cs corresponding to the counted numbers are output to the conversion processor 314.

The conversion processor 314 outputs the light control signals based on the counting signals Cs output from the counter 313 and the digital sensing signals output from the A/D converter 312. The conversion processor 314 outputs light control signals corresponding to the selected digital sensing signals supplied from the A/D converter 312, when the counter 313 outputs predetermined signals, and maintains outputting the light control signals for one frame period that is counted by the counter 313. The conversion processor 314 resets the light control signals in the beginning of the next frame, and outputs light control signals corresponding to the next digital sensing signals output from the A/D converter 312, and maintains the output of the next sensing signals for another frame. For example, the conversion processor 314 outputs a light control signal corresponding to the digital sensing signal of “11” if the ambient brightness is the brightest, and maintains the light control signal during one frame period while the counter 313 performs the counting. The conversion processor 314 outputs a light control signal corresponding to the digital sensing signal of “00” if the ambient brightness is the darkest, and maintains the light control signal during one frame period while the counter 313 performs the counting. If the ambient light is less bright state or the ambient light is less dark state, the conversion processor 314 outputs a light control signal corresponding to the digital sensing signals of “10” or “01” and maintains the signal during one frame.

FIG. 5 is a view showing a diagram of one example of a correction unit shown in FIG. 2. Referring to FIG. 5, the correction unit 400 includes a first signal processor 414, a register generator 415, a first selector 416, and a second selector 417. Signals output from the second selector 417 are transferred to a gamma correction circuit 610 that is included in the data driver 600.

The first signal processor 414 receives the light control signals and the temperature compensation (or correction) signals, and generates selection signals that is to be input to the first selector 416. For a method of generating the selection signals, there is a method of performing an addition operation of the light control signals and the temperature compensation signals. If “1” is selected in the light control signal and “1” is selected in the temperature compensation signal, the signals are added, and “2” can be selected in the first selector 416.

The register generator 415 includes a plurality of registers. Each register stores an unique register value so that the register generator 415 can use different register values according to the brightness of the ambient light or the ambient temperature.

The first selector 416 selects one of the register values among a plurality of register values stored in the register unit 415. The selected register value corresponds to the selection signals set by the first signal processor 414. The register value of the selected register is the gamma correction signal, and the first selector 416 outputs the selected register value to the second selector 417.

The second selector 417 receives a on/off controlling setting value of I bit from an external apparatus. If “1” is selected in the on/off controlling setting value, the second selector 417 outputs the signal output from the first selector 416, and if “0” is selected, outputs an off signal. If the off signal is output, the temperature compensation and the ambient light compensation processes are not performed.

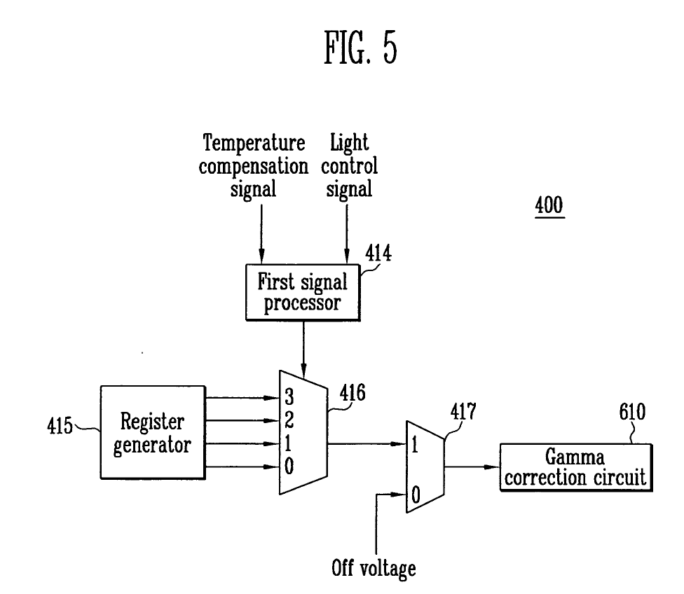

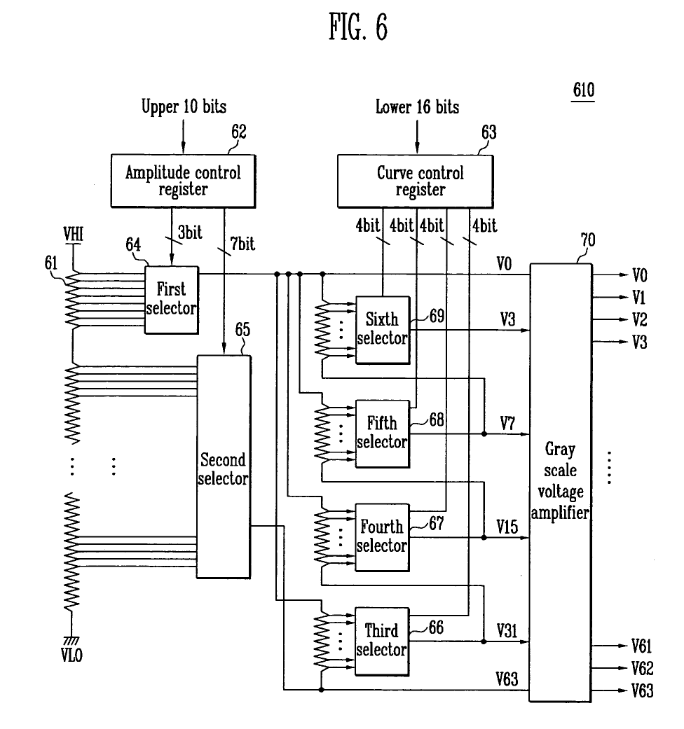

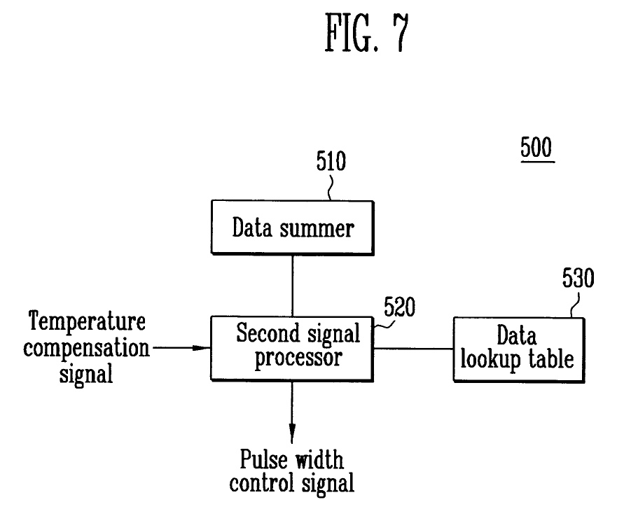

FIG. 6 is a view showing a diagram of one example of a gamma correction circuit shown in FIG. 2. Referring to FIG. 6, the gamma correction circuit 610 includes a ladder resistor 61, an amplitude control register 62, a curve control register 63, a first selector 64 to a sixth selector 69, and a gray scale voltage amplifier 70.

The ladder resistor 61 defines uppermost voltage level VHI supplied from an external apparatus as reference voltage level, and defines various voltage levels through a plurality of variable resistors, which are serially coupled between lowermost voltage level VLO and the reference voltage level. A plurality of gray scale voltages are generated through the ladder resistor 61. If the maximum resistance of the ladder resistor 61 is small, the amplitude control range becomes narrow but the control precision is improved. On the other hand, if the maximum resistance of the ladder resistor 61 is large, the amplitude control range becomes wide but the control precision is degraded.

The amplitude control register 62 outputs a register setting value of 3 bits to the first selector 64, and outputs a register setting value of 7 bits to the second selector 65. At this time, the number of the selectable gray scales can be increased by increasing the number of the set bits, and the gray scale voltages can be differently selected by changing the register setting values.

The curve control register 63 outputs a register setting value of 4 bits to each of the third selector 66 to the sixth selector 69. At this time, the register setting values can be changed and the selectable gray scale voltages can be controlled according to the register setting values.

Upper 10 bits of the register values generated from the register generator 415 are input to the amplitude control register 62, and lower 16 bits of the register values are input to the curve control register 63, so that they are selected as the register setting values.

The first selector 64 selects a gray scale voltage, which corresponds to the register setting value of 3 bits set in the amplitude control register 62, among the plurality of gray scale voltages distributed through the ladder resistor 61, and outputs the selected gray scale voltage as the uppermost gray scale voltage.

The second selector 65 selects a gray scale voltage, corresponding to the register setting value of 7 bits set in the amplitude control register 62, among the plurality of gray scale voltages divided through the ladder resistor 61, and outputs the selected gray scale voltages as the lowest gray scale voltage.

The third selector 66 divides the voltage between the gray scale voltage output from the first selector 64 and the gray scale voltage output from the second selector 65 into a plurality of gray scale voltages through a plurality of resistors, and selects a gray scale voltage corresponding to the register setting value of 4 bits and outputs the selected gray scale voltage.

The fourth selector 67 divides the voltage between the gray scale voltage output from the first selector 64 and the gray scale voltage output from the third selector 66 into the plurality of gray scale voltages through a plurality of resistors, and selects the gray scale voltage corresponding to the register setting value of 4 bits, and outputs the selected gray scale voltage.

The fifth selector 68 selects a gray scale voltage corresponding to the register setting value of 4 bits of the gray scale voltages among a plurality of voltages that can be obtained by dividing the voltages between the first selector 64 and the fourth selector 67 through a plurality of resistors, and outputs the selected gray scale voltage.

The sixth selector 69 selects a gray scale voltage corresponding to the register setting value of 4 bits of the plurality of gray scale voltages among a plurality of voltages that can be obtained by dividing the voltages between the first selector 64 and the fifth selector 68 through a plurality of resistors, and outputs the selected gray scale voltage.

Through the above operations, a curve control among intermediate gray scales can be realized according to the register setting values of the curve control register 63. Therefore, the control of the gamma characteristics can be easily realized according to required characteristics of the light emitting devices. For example, the resistance values of the respective ladder resistors 61 can be set in a manner that if the gamma curve is to be concave, the difference between levels of the gray scale is set to be larger with lower levels of the gray scale, while if the gamma curve is to be convex, the difference between levels of the gray scale is set to be smaller with the lower levels of the gray scale.

The gray scale amplifier 70 outputs the plurality of gray scale voltages corresponding to each of the plurality of gray scales to be displayed on the pixel unit 100.

In the above-mentioned operations, variations of each light emitting diode that produces red (R), green (G), or blue (B) light can be considered. Gamma correction circuits can be separately installed for a group of R, G, or B light emitting diodes, in order to make the R, G, and B light emitting diodes have substantially the same luminance characteristics. The voltage levels in the gray scale and the form of curve can be differently set for R, G, and B light emitting diodes through the curve control register 63 and the amplitude control register 62.

FIG. 7 is a diagram showing one example of a luminance controller adopted in the organic light emitting display of the present invention. Referring to FIG. 7, the luminance controller 500 includes a data summer 510, a second signal processor 520, and a data lookup table 530.

The data summer 510 extracts information from a frame data that is a summation of video data of red, blue, and green inputs in one frame. The frame data is a summation of gray levels of R, B, and G image signals of a single image frame. If the value of the frame data is large, the frame data includes more data representing pixels with high luminance (or higher gray level), and if the value of the frame data is small, the frame data includes less data representing pixels with high luminance. Therefore, a ratio of light emitting area of the pixel unit can be predicted by the magnitude of the value of the frame data. The ratio of light emitting area is defined according to the following Equation 1.

Ratio of light emitting area=luminance in one frame/luminance in full white Equation 1

The second signal processor 520 outputs pulse width control signals to change the pulse widths of the light emitting control signals. The second signal processor 520 receives the information from the frame data, and looks up a data lookup table 530 to generate the pulse width control signal based on the information from the frame data. The second processor 520 receives the temperature compensation signals, and also refers to the temperature compensation signals to generate the pulse width control signal. For example, if the value of the frame data is “12” and the temperature compensation signal has the value of “1”, the second signal processor 520 adds the value of the frame data “12” to the value of the temperature compensation signal “l ” to make “13.” The second signal processor 520 generates the pulse width control signal that corresponds to the value “13” in the data lookup table 530.

The pulse width control signal can be used as a start pulse transferred to the light emitting controller 800. The width of the light emitting control signal can be determined by the widths of the start pulse. The data lookup table 530 includes pulse widths of light emitting control signals as a function of an input parameter. The input parameter can be the value of the frame data, the value of the temperature compensation signal, or the sum of them. For example, if the value of the frame data is one of 0 to 63, the data lookup table 530 includes an array of widths of the light emitting period of the light emitting control signal, which is one-to-one corresponds to the numbers 0 to 63.

Although exemplary embodiments of the present invention have been shown and described, it would be appreciated by those skilled in the art that changes might be made in this embodiment without departing from the principles and spirit of the invention, the scope of which is defined in the claims and their equivalents.

What is claimed is:

1. An organic light emitting display comprising:
a pixel unit for displaying an image;
a temperature sensor unit for measuring ambient temperature, and outputting a temperature compensation signal representing the ambient temperature;
a light sensor unit for sensing intensity of ambient light, and outputting a light control signal representing the intensity of the ambient light;
a correction unit receiving the temperature compensation signal and the light control signal, the correction unit outputting a gamma correction signal corresponding to the temperature compensation signal and the light control signal; and
a data driver receiving the gamma correction signal, and generating a data signal corresponding to the gamma correction signal, the data driver supplying the data signal to the pixel unit in order to drive the pixel unit.

2. The organic light emitting display as claimed in claim 1, wherein the temperature sensor unit comprises:
a temperature sensing sensor measuring the ambient temperature;
a temperature lookup table storing correction values that depends on the ambient temperature; and
a signal generator coupled to the temperature sensing sensor and the temperature lookup table, the signal generator looking up the temperature lookup table to find a correction value of the measured ambient temperature, the signal generator outputting the temperature compensation signal corresponding to the found correction value.

3. The organic light emitting display as claimed in claim 1, wherein the correction unit comprises:
a first signal processor receiving the temperature compensation signal and the light control signal, and outputting a selection signal corresponding to the temperature compensation signal and the light control signal;
a register unit including a plurality of registers, each of the registers having a unique register value; and
a first selector selecting one of the registers based on the selection signal, the first selector outputting the register value of the selected register as the gamma correction signal.

4. The organic light emitting display as claimed in claim 3, wherein the data driver further comprises a gamma correction circuit receiving the gamma correction signal, the gamma correction circuit performing a gamma correction based on the gamma correction signal.

5. The organic light emitting display as claimed in claim 3, wherein the first signal processor adds the temperature compensation signal to the light control signal to generate the selection signal.

6. An organic light emitting display comprising:
a pixel for emitting light;
a temperature sensor unit sensing ambient temperature, and outputting a temperature compensation signal-corresponding to the ambient temperature; and
a luminance controller receiving the temperature compensation signal and image signals, the luminance controller controlling a pulse width of a light emitting control signal based on the temperature compensation signal and the image signals, the light emitting control signal controlling light emission of the pixel.

7. The organic light emitting display as claimed in claim 6, wherein the temperature sensor unit comprises:
a temperature sensing sensor measuring the ambient temperature;
a temperature lookup table storing correction values that depends on the ambient temperature; and
a signal generator coupled to the temperature sensing sensor and the temperature lookup table, the signal generator looking up the temperature lookup table to find a correction value of the measured ambient temperature, the signal generator outputting the temperature compensation signal corresponding to the found correction value.

8. The organic light emitting display as claimed in claim 6, wherein the luminance controller comprises:
a data summer adding gray levels of the image signals of a single image frame to generate frame data;
a data lookup table storing pulse widths of the light emitting control signals as a function of an input parameter; and
a second signal processor coupled to the data summer and the data lookup table, the second signal processor receiving the temperature compensation signal, the second signal processor generating the input parameter based on the temperature compensation signal and the frame data, the second signal processor looking up the data lookup table to find a width of the light emitting control signal corresponding to the input parameter, the second signal processor outputting a pulse width control signal to control the pulse width of the light emitting control signal.

9. The organic light emitting display as claimed in claim 8, wherein the pulse width control signals are start pulses transferred to the light emitting control driver.

10. An organic light emitting display comprising:
a pixel unit for displaying an image, the pixel unit including a plurality pixels for emitting light;
a temperature sensor unit for measuring ambient temperature, and outputting a temperature compensation signal representing the ambient temperature;
a light sensor unit for sensing intensity of ambient light, and outputting a light control signal representing the intensity of the ambient light;
a correction unit receiving the temperature compensation signal and the light control signal, the correction unit outputting a gamma correction signal corresponding to the temperature compensation signal and the light control signal;
a data driver receiving the gamma correction signal, and generating a data signal corresponding to the gamma correction signal, the data driver supplying the data signal to the pixel unit in order to drive the pixel unit; and
a luminance controller receiving the temperature compensation signal and image signals, the luminance controller controlling a pulse width of a light emitting control signal based on the temperature compensation signal and the image signals, the light emitting control signal controlling light emission from the pixel.

11. The organic light emitting display as claimed in claim 10, wherein the temperature sensor unit comprises:
a temperature sensing sensor measuring the ambient temperature;
a temperature lookup table storing correction values that depends on the ambient temperature; and
a signal generator coupled to the temperature sensing sensor and the temperature lookup table, the signal generator looking up the temperature lookup table to find a correction value of the measured ambient temperature, the signal generator outputting the temperature compensation signal corresponding to the found correction value.

12. The organic light emitting display as claimed in claim 10, wherein the correction unit comprises:
a first signal processor receiving the temperature compensation signal and the light control signal, and outputting a selection signal corresponding to the temperature compensation signal and the light control signal;
a register unit including a plurality of registers, each of the registers having a unique register value; and
a first selector selecting one of the registers based on the selection signal, the first selector outputting the register value of the selected register as the gamma correction signal.

13. The organic light emitting display as claimed in claim 12, wherein the first signal processor adds the temperature compensation signal to the light control signal to generate the selection signal.

14. The organic light emitting display as claimed in claim 12, wherein the data driver further comprises a gamma correction circuit receiving the gamma correction signal, the gamma correction circuit performing a gamma correction based on the gamma correction signal.

15. The organic light emitting display as claimed in claim 10, wherein the luminance controller comprises:
a data summer adding the image signals of a frame to generate frame data;
a data lookup table storing pulse widths of the light emitting control signals as a function of an input parameter; and
a second signal processor coupled to the data summer and the data lookup table, the second signal processor receiving the temperature compensation signal, the second signal processor generating the input parameter based on the temperature compensation signal and the frame data, the second signal processor looking up the data lookup table to find a width of the light emitting control signal corresponding to the input parameter, the second signal processor outputting a pulse width control signal to control the pulse width of the light emitting control signal.

16. The organic light emitting display as claimed in claim 15, wherein the input parameter is generated by adding the temperature compensation signal to the frame data.

17. A driving method of an organic light emitting display having a pixel unit for displaying an image, the method comprising:
measuring ambient temperature;
generating a temperature compensation signal that represents the ambient temperature;
measuring intensity of ambient light;
generating a light control signal that represents the intensity of ambient light;
generating a data signal that depends on the temperature compensation signal and the light control signal; and
transferring the data signal to the pixel unit to drive the pixel unit.

18. The driving method of an organic light emitting display as claimed in claim 17, wherein the generating the data signals comprising:
dividing a plurality of steps corresponding to the luminance of ambient light;
setting a plurality of correction values corresponding to each step; and
selecting one of the plurality of steps corresponding to the light control signals and the temperature compensation signals.

19. A driving method of an organic light emitting display including a pixel for emitting light, the method comprising:
measuring ambient temperature;
generating a temperature compensation signal that represents the ambient temperature;
generating a frame data by adding gray levels of image signals of a single image frame;
determining a pulse width of a light emitting control signal based on the temperature compensation signal and the frame data, the light emitting control signal controlling light emission of the pixel.

20. The driving method of an organic light emitting as claimed in claim 19, wherein the step of determining a pulse width of a light emitting control signal comprising:
generating an input parameter by adding the temperature compensation signal to the frame data; and
looking up a data lookup table to find a width of the light emitting control signal corresponding to the input parameter.
